(19) United States
(12) Patent Application Publication
(10) Pub. No.: US 2010/0284425 A1
(43) Pub. Date: Nov. 11, 2010

(54) SYSTEM AND METHOD OF USING TDM VARIABLE FRAME LENGTHS IN A TELECOMMUNICATIONS NETWORK

(76) Inventor: David Hood, Palo Alto, CA (US)

Correspondence Address: ERICSSON INC., 6300 LEGACY DRIVE, M/S EVR 1-C-11, PLANO, TX, 75024, US

(21) Appl. No.: 12/463,697

(22) Filed: May 11, 2009

(51) Int. Cl. H04J 3/22

(52) U.S. Cl. 370/471

(57) ABSTRACT

A system, method, and node for efficiently packing payload of variable or arbitrary frame lengths into a TDM telecommunications system transmission. A transmitting unit transmits a plurality of frames whose concatenation does not precisely fit into the interval between TDM framing synchronization patterns to a receiving unit. An offset value is determined, which specifies the consequent delay in transmission of a TDM framing synchronization pattern. The offset value is then sent to the receiving unit in conjunction with the TDM framing signal. The receiving unit receives the plurality of frames and the offset value and reconstructs a precise reference instant derived from the offset value. By reconstructing the precise interval boundary, the receiving unit remains synchronized with the transmitting unit.

### BACKGROUND

The present invention relates to communications networks. More particularly, and not by way of limitation, the present invention is directed to a system and method utilizing variable frame lengths in a Time Division Multiplex (TDM) frame within a telecommunications network.

Digital transmission utilizing TDM technology is well-known in telecommunication systems. Such transmission has been deployed for many years. TDM technology employs so-called frames that typically have a duration of 125 microseconds. The beginning of each frame is normally signaled with a well-known bit pattern that assists receiving devices in recovering frame alignment, thereby facilitating recovery of the payload content of the frame. This pattern comprises part or all of a so-called TDM framing pattern or frame synchronization pattern.

Many telecommunications services, such as digital TDM telephony and digital leased line services, are based on the concept of a repetitive frame. However, the telecommunications network is rapidly migrating to a packet-based network in which there is no concept of a repetitive frame. However, such packet-based networks must continue to support legacy TDM services.

Some telecommunications protocols, such as those used in Gigabit-capable Passive Optical Networks (GPON), retain the concept of a precisely repeated framing pattern while fitting arbitrary payload fragments into the intervals between successive framing patterns. These arbitrary payload fragments are also typically called frames. In discussions of the present invention, frame types are distinguished either as TDM frames having a repetitive timing recovery frame type or as payload frames.

There are several problems with existing systems. The TDM framing synchronization pattern must recur at precisely repeated instants, which are referred to below as “reference instants”. Because payload frames may have arbitrary length, each potentially different from the other, there is a difficulty in fitting payload frames into an inter-TDM frame interval.

Currently there are two solutions utilized to overcome this problem. First, a lower-layer framing mechanism may be defined as part of the transmission protocol. In this existing system, a mechanism permits the fragmentation of payload frames such that the inter-TDM framing interval can be fully packed with these lower-layer frames and frame fragments, while a fragmented payload frame is reassembled from lower-layer frame fragments at the receiving end. This approach is taken in GPON, for example, whereby Ethernet payload frames are fragmented into so-called GEM (GPON encapsulation method) frames. A disadvantage of this approach is there is a significant hardware cost to reassemble payload frames.

FIG. 1 is a diagram illustrating a fragmentation of a frame for a framing pattern 10 in a first existing system. The framing pattern includes TDM framing patterns (FP) 12 which are transmitted at a precise time interval Y. The reference instants 24, 26, and 28 designate precisely-spaced time references that recur at rate Y. The time available for payload frames is the remainder of the time between framing patterns FP, a constant value that is designated X. Between each FP 12 are payload frames (Pay) 16 of possibly arbitrary or variable length. As illustrated, there is an oversized payload frame 18 which cannot be fully transmitted in the time interval X. Thus, in the existing system, the payload frame 18 is fragmented and transmitted partially during a first interval 20 and partially transmitted after the FP in a second interval 22.

In a second existing solution, the transmission logic may inspect each payload frame before transmitting it and transmit the frame only if there remains enough time in the inter-TDM framing interval X for the complete payload frame. X is the nominal time available for payload frames and does not vary in existing solutions. If there is not enough time, the frame is held until after the TDM framing pattern FP. It is typically not feasible to transmit some other (smaller) payload frame instead, so that the trailing end of the inter-TDM framing interval is left unused, which represents a loss in transmission capacity.

FIG. 2 illustrates in high level diagram 50, deferral of a frame for a framing pattern in a second existing system. As discussed above, the frame includes framing patterns FP 12, which are transmitted at a precise time interval having a duration of Y, and which designate reference instants 24, 26, and 28. Between each FP 12 is an invariant interval X during which payload frames 16 are transmitted. The oversized payload frame 40 is deferred from a first frame position 52 to a second frame position 54 after the FP 12. With this solution, capacity is wasted at positions 56 and 58. Both of these existing systems do not provide a sufficient solution to the problems of utilizing frames within a TDM system.

### SUMMARY

The present invention utilizes a TDM frame synchronization pattern which occurs at approximate intervals rather than at precisely periodic time intervals. The receiver of a transmission may reconstruct the precise reference time at which TDM framing pattern would have occurred through compensation with a dynamic offset indicator, which is transmitted in conjunction with the TDM framing pattern itself. Thus, it is possible to avoid the need to fragment payload frames, while retaining a reliable timing reference for TDM-domain applications.

In one aspect, the present invention is directed at a method of using variable payload frame lengths in a telecommunications system. During the interval between TDM framing patterns, a transmitting unit transmits a plurality of payload frames having arbitrary or variable frame length to a receiving unit, allowing the final payload frame to extend, if necessary, beyond the next reference instant. The transmitting unit then transmits the TDM frame synchronization pattern FP. The transmitting unit determines an offset value, which specifies the amount of delay imposed on the TDM frame synchronization pattern FP. The offset value is then sent to the receiving unit. The receiving unit receives the plurality of frames and the offset value and reconstructs the reference instant derived from the offset value. By reconstructing the precise reference instant, the receiving unit remains synchronized with the transmitting unit.

In another aspect, the present invention is directed at a system for using variable frame lengths in a telecommunications system. The system includes a transmitting unit that, during the interval between TDM framing patterns, transmits payload frames having arbitrary or variable frame length, allowing the final payload frame to extend, if necessary, beyond the next reference instant. The transmitting unit then transmits the TDM framing pattern FP. The transmitting unit determines an offset value, which specifies the amount of delay imposed on the TDM framing pattern FP. The system includes a receiving unit for receiving the plurality of frames and the offset value from the transmitting unit. The receiving unit also includes a reconstruction unit for reconstructing a precise reference instant derived from the offset value. By reconstructing the precise reference instant, the receiving unit remains synchronized with the transmitting unit.

In still another aspect, the present invention is directed at a node for using variable payload frame lengths in a telecommunications system. The node receives a plurality of frames having a variable or arbitrary frame length. The node also receives a TDM framing pattern whose position in time is delayed, possibly by zero, from the precise reference instant at which it would nominally have occurred. The node also receives an offset value providing an amount of deviation from the reference instant. In addition, the node reconstructs the precise reference instant derived from the offset value. By reconstructing the precise reference instant, the node remains synchronized with a transmitting unit transmitting the plurality of frames.

### BRIEF DESCRIPTION OF THE DRAWINGS

In the following section, the invention will be described with reference to exemplary embodiments illustrated in the figures, in which:

FIG. 1 (prior art) is a diagram illustrating a fragmentation of a frame for a framing pattern in a first existing system;

FIG. 2 (prior art) is a diagram illustrating deferral of a frame for a framing pattern in a second existing system;

FIG. 3 is a simplified block diagram of several components of a TDM system in one embodiment of the present invention;

FIG. 4 is a diagram illustrating the TDM framing pattern 110 utilized with the system of FIG. 3; and

FIG. 5 is a flow chart illustrating the steps of utilizing the frame pattern in the TDM system according to the teachings of the present invention.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

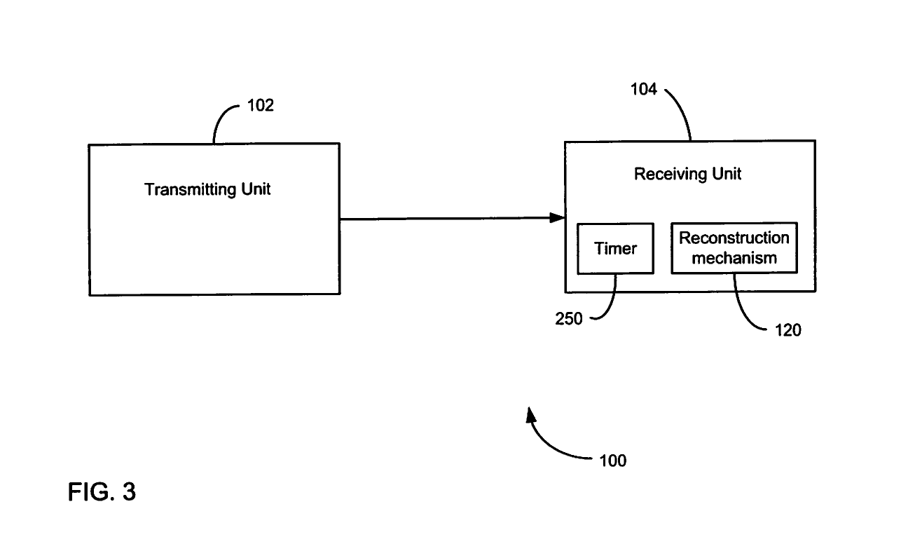

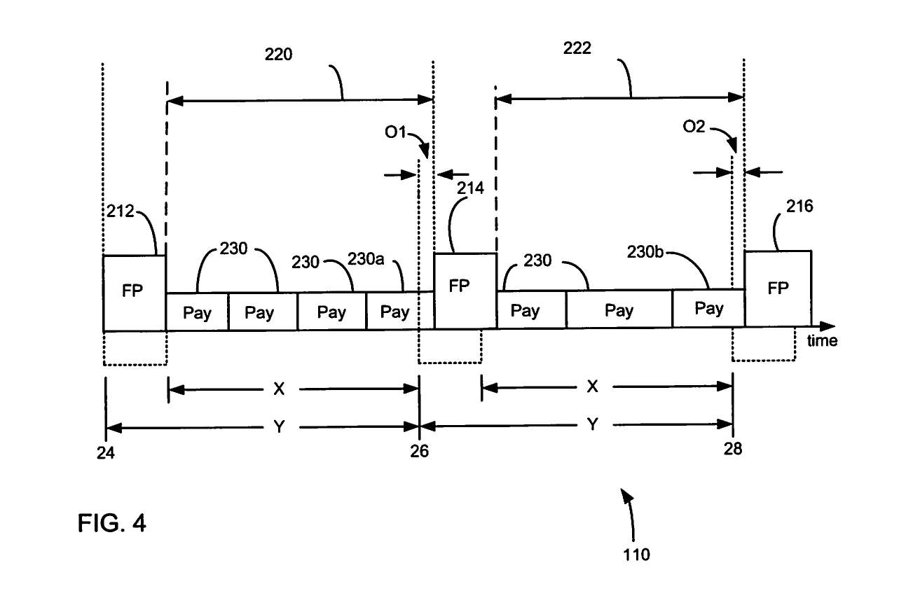

The present invention is a system and method utilizing variable frame synchronization transmission intervals in a framing pattern of a TDM system. FIG. 3 is a simplified block diagram of several components of a TDM system 100 in one embodiment of the present invention. The TDM system includes a transmitting unit 102 and a receiving unit 104. The transmitting unit 102 transmits signals utilizing a TDM framing pattern 212 (shown in FIG. 4) to the receiving unit 104. The transmitting unit may be any node or device which transmits signals, such as a mobile station, a base station, etc. Additionally, the receiving unit may be any node or device which receives signals from the transmitting unit, such as mobile station, etc.

TDM framing pattern 212 may be transmitted at irregular or regular intervals. The receiving unit includes a reconstruction mechanism 120 for reconstructing the corresponding precise reference instants. This reconstruction mechanism permits complete pay-load frames to be transmitted at the end of an inter-TDM framing interval without fragmentation or lost transmission capacity.

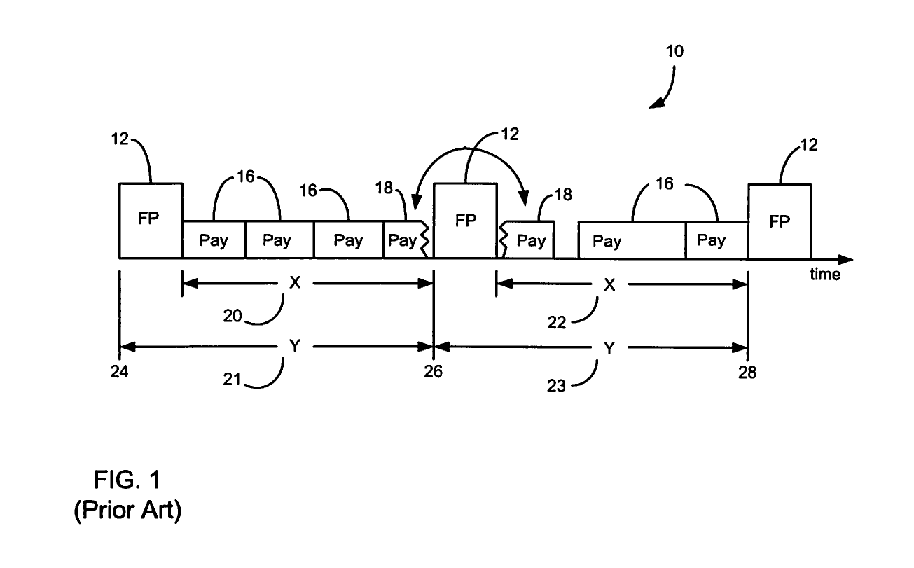

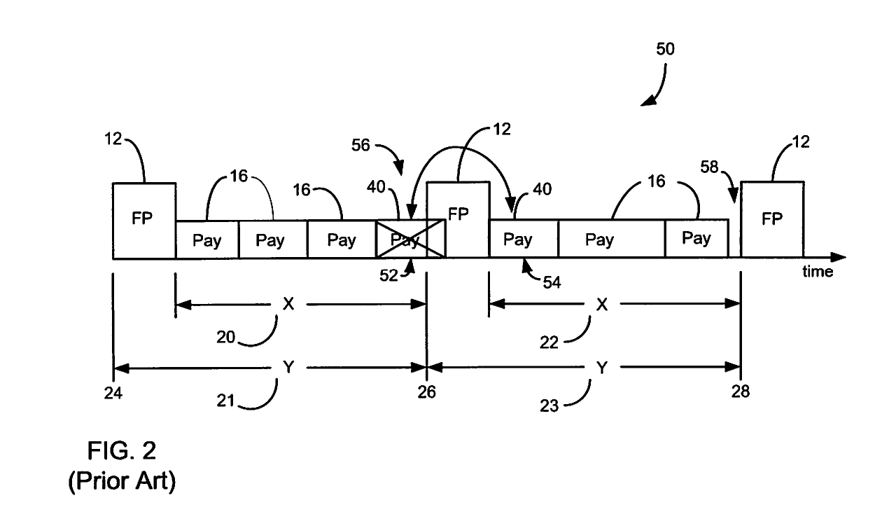

The offset time from the reference instant may be conveyed as a field in, or in conjunction with, the TDM framing pattern itself. FIG. 4 is a diagram illustrating the TDM framing pattern 212 utilized with the TDM system of FIG. 3. The time sequence of the TDM transmission protocol includes TDM frame synchronization pattern frames (FP) 212, 214, and 216. The FP 214 is transmitted after a payload interval 220 and the transmission of the previous FP 212. The FP 216 is transmitted after a payload interval 222 and the transmission of the previous FP 214. Between each consecutive pair of FPs are payload frames (Pay) 230 of possibly arbitrary or variable length. As depicted in FIG. 4, payload frame 230a causes inter-TDM framing interval 220 to be extended by an offset O1 from a precise reference instant 26, recurring with duration Y. This reference instant, as discussed for FIGS. 1 and 2 is the instant at which each FP is nominally transmitted. The value of O1 may be encoded into a data field of, or added to, FP 214. A timer (or counter) 250 in the receiving unit 104 may be used to predict the reference instant in real time, and its prediction may be verified and corrected according to the received value of the offset value O1. O1 may be expressed as any value providing information on the offset of FP 214, such as in bit or byte times. Thus, a zero reference may be derived from the offset to allow the receiving unit to be synchronized with the transmitting device.

In addition, FIG. 4 illustrates an extension of the payload interval 222 by yet another complete (non-fragmented) payload frame 230b and the encoding of a new offset value O2 which is transmitted in, or in conjunction with, the TDM frame pattern FP 216.

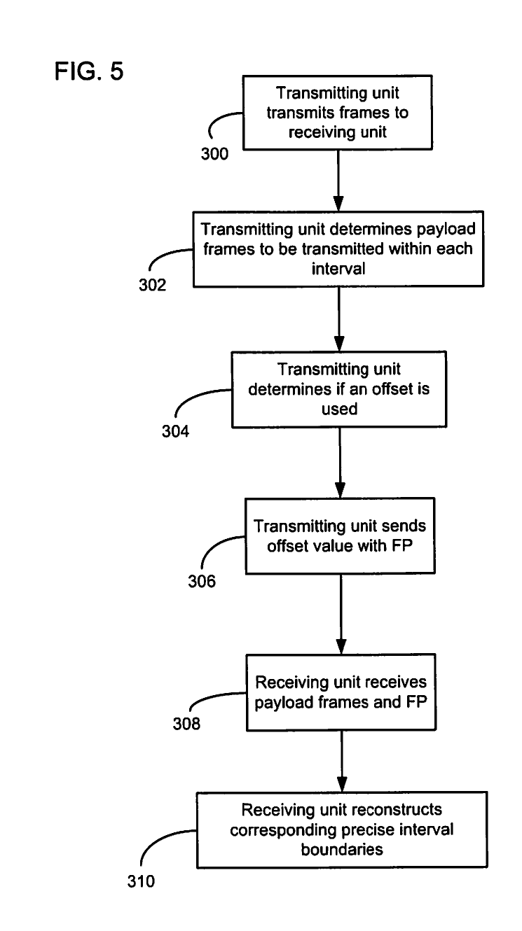

FIG. 5 is a flow chart illustrating the steps of utilizing the frame pattern 110 in the TDM system 100 according to the teachings of the present invention. With reference to FIGS. 3-5, the method will now be explained. The method begins with step 300 where the transmitting unit 102 transmits messages as frames to the receiving unit 104. The transmitting unit 102 sends the messages according to the frame pattern 110 which utilizes approximate intervals rather than precisely periodic intervals. In step 302, the transmitting unit 102 determines which frames may be transmitted within an approximate (variable) pay-load interval (e.g., interval 220 or 222). Next, in step 304, the transmitting unit 102 determines if the framing interval 220 or 222 is to be extended by an offset (e.g., O1 or O2). Thus, between each FP are payload frames (Pay) 230 of possibly arbitrary or variable length. For example, as depicted in FIG. 4, payload frame 230a causes inter-TDM framing interval 220 to be extended by the offset 01 from the precise reference instant 26. In step 306, the transmitting unit sends the value of the offset, possibly zero, to the receiving unit 104 via the FP, such as FP 214 or 216. The value of O1 may be encoded into a data field within FP 214. Next, in step 308, the receiving unit 104 receives the payload frames 230 and the FP having the encoded value of the offset. In step 310, the reconstruction mechanism 120 within the receiving unit reconstructs the corresponding precise reference instant 26. Furthermore, the timer or counter 250 in the receiving unit 104 may optionally be used to predict the reference instant in real time, and its prediction may be verified and corrected according to the received value of the O1 measurement. O1 may be expressed as any value providing information on the offset from the reference instant, such as in bit or byte times.

In one embodiment of the present invention, the framing may be carried in the transport definition of the framing pattern, such as the section overhead of Synchronous Optical Network (SONET) or Synchronous Digital Hierarchy (SDH). The present invention is suitable for GPON and proposed 10G descendents. However, in another embodiment of the present invention, the present invention may be employed in a pure Ethernet transport system wherein all intelligence is carried in Ethernet frames. Variable frames may be used and received in the same manner as discussed above, but where the timing reference field is carded in a packet as ordinary traffic. This timing reference may specify the instant of occurrence of a well-known component of the packet, such as the boundary between the packet header and the packet body.

The present invention provides many advantages over existing systems and methods. The present invention avoids the need to fragment payload frames and reassemble the fragmented frames on the receiving end. Furthermore, the present invention avoids the requirement to determine whether a payload frame can or cannot be transmitted during the current interval as well as avoids losing transmission capacity in the event that a candidate payload frame is too large to be transmitted immediately.

As will be recognized by those skilled in the art, the innovative concepts described in the present application can be modified and varied over a wide range of applications. Accordingly, the scope of patented subject matter should not be limited to any of the specific exemplary teachings discussed above, but is instead defined by the following claims.

1. A method of using variable frame lengths in a telecommunications system, the method comprising the steps of:
transmitting by a transmitting unit a plurality of frames having a variable or arbitrary frame length, the concatenation of which exceeds the time available for payload frame transmission prior to the next succeeding repetitive reference instant, to a receiving unit, for deferring the transmission of the frame pattern reference from its nominal reference instant of transmission;
determining an offset value that specifies the delay in frame pattern transmission;
sending the offset value to the receiving unit;
receiving the plurality of frames having a variable or arbitrary frame length, a frame pattern reference signal, and the offset value at the receiving unit; and
reconstructing a reference instant derived from the offset value.

2. The method according to claim 1 wherein the step of reconstructing a precise reference instant includes
synchronizing, by the receiving unit, with the transmitting unit;
accepting, by the receiving unit the plurality of frames having a variable or arbitrary frame length, one frame of which forms a frame synchronization pattern (FP) displaced in time by the offset value; and
deriving a zero reference for the specified frame synchronization pattern to enable the receiving unit to remain in synchronization with the transmitting unit.

3. The method according to claim 1 wherein the step of sending the offset value includes sending the offset value within a frame pattern (FP) frame to the receiving unit, the offset value being encoded within a data field of the FP.

4. The method according to claim 3 wherein the offset value is encoded within a data field of the FP.

5. The method according to claim 1 wherein the step of transmitting a plurality of frames includes the step of forming a framing pattern within a transport definition of the framing pattern.

6. The method according to claim 5 wherein the framing pattern is carried in a section overhead of a Synchronous Optical Network (SONET) or a section overhead of Synchronous Digital Hierarchy (SDH) frames.

7. The method according to claim 1 wherein the telecommunication network is a Gigabit-capable Passive Optical Network (GPON).

8. The method according to claim 1 wherein the step of transmitting a plurality of frames includes utilizing an Ethernet transport system using Ethernet frames.

9. The method according to claim 1, the step of reconstructing a reference instant including deriving a timing reference from the offset value to specify an instant of occurrence of a component of the frame, the time reference providing a prediction verified and corrected by the offset value.

10. The method according to claim 1 wherein the step of reconstructing a reference instant includes utilizing a timer in the receiving unit to predict the reference instant in real time.

11. A system for using variable frame lengths in a telecommunications system, the system comprising:
a transmitting unit for transmitting a plurality of frames having a variable or arbitrary frame length, the concatenation of which exceeds the time available for payload frame transmission prior to the next succeeding repetitive reference instant, thereby deferring the transmission of the frame pattern reference from its nominal reference instant of transmission;
determining means within the transmitting unit for determining an offset value that specifies the delay in frame pattern transmission from its nominal reference instant;
the transmitting unit for transmitting the offset value;
a receiving unit for receiving the plurality of frames having a variable or arbitrary frame length, a frame pattern reference signal, and the offset value from the transmitting unit; and
a reconstruction mechanism within the receiving unit for reconstructing a reference instant derived from the offset value.

12. The system according to claim 11 wherein the reconstruction mechanism includes means for synchronizing the receiving unit with the transmitting unit.

13. The system according to claim 11 wherein the reconstruction mechanism includes means for accepting the plurality of frames having a variable or arbitrary frame length, one frame of which forms a frame synchronization pattern (FP) displaced in time by an offset value.

14. The system according to claim 11 wherein the reconstruction mechanism includes means for deriving a zero reference instant for the specified frame synchronization pattern to enable the receiving unit to remain in synchronization with the transmitting unit.

15. The system according to claim 11 wherein the means for sending the offset value includes means for sending the offset value within a frame synchronization pattern (FP) frame to the receiving unit.

16. The system according to claim 11 wherein the means for transmitting a plurality of frames includes means for conveying offset information within a transport definition of the framing pattern.

17. The system according to claim 11 wherein the telecommunication system is a Gigabit-capable Passive Optical Network (GPON).

18. The system according to claim 11 wherein the means for transmitting a plurality of frames includes utilizing a pure Ethernet transport system using Ethernet frames.

19. The system according to claim 11 wherein the reconstruction mechanism includes means for deriving a timing reference from the offset value to specify an instant of occurrence of a component of the frame.

20. The system according to claim 19 wherein the time reference provides a prediction verified and corrected by the offset value.

21. The system according to claim 11 wherein the reconstruction mechanism utilizes a timer to predict the reference instant in real time.

22. A node for using variable frame lengths in a telecommunications system, the node comprising:
means for receiving a plurality of frames having variable or arbitrary frame lengths and a frame synchronization reference signal;
means for receiving an offset value, the offset value providing an amount of deviation from the specified frame synchronization reference signal; and
means for reconstructing a precise reference instant derived from the offset value.

23. The node according to claim 22 wherein the means for reconstructing includes means for synchronizing the node with a transmitting unit transmitting the plurality of frames.

24. The node according to claim 22 wherein the means for reconstructing a reference instant includes means for accepting the plurality of frames having variable or arbitrary frame lengths, one frame of which forms a frame synchronization pattern (FP) displaced in time by the offset value.

25. The node according to claim 22 wherein the means for reconstructing includes means for deriving a zero reference for the specified frame synchronization pattern to enable the node to remain in synchronization with a transmitting unit transmitting the plurality of frames.

26. The node according to claim 22 wherein the offset value is received within a frame pattern (FP) frame.

30. The node according to claim 22 wherein the means for reconstructing includes means for deriving a timing reference from the offset value to specify an instant of occurrence of a component of the frame.

31. The node according to claim 30 wherein the time reference provides a prediction verified and corrected by the offset value.

32. The node according to claim 22 wherein the means for reconstructing utilizes a timer to predict the reference instant in real time.
